(19) United States
(12) Patent Application Publication
(10) Pub. No.: US 2026/0335765 A1
(43) Pub. Date: Oct. 29, 2026

(54) ONE OR MORE STORAGE MEDIA, INFORMATION PROCESSING SYSTEM, AND COMPUTER-IMPLEMENTED METHOD

(71) Applicants: Nintendo Co., Ltd., Kyoto (JP); The Pokémon Company, Tokyo (JP)

(72) Inventors: Tomohisa HISHINUMA, Kyoto (JP); Rita GUNJI, Kyoto (JP)

(21) Appl. No.: 19/391,651

(22) Filed: Nov. 17, 2025

(30) Foreign Application Priority Data
Apr. 28, 2025 (JP) 2025-074518

(51) Int. Cl. A63F 13/56

(52) U.S. Cl. CPC A63F 13/56

(57) ABSTRACT

An example information processing system sets a candidate position in a first range, the first range being set with respect to a reference position, the reference position being set based on at least one of a position of a player character and a position of a virtual camera. Where no obstruction exists between a second reference position and the candidate position, a non-player object is placed based on the candidate position. Where an obstruction exists between the second reference position and the candidate position, and where a third reference position and the candidate position are both in a second range set in a field or are both in a third range set outside the second range, a non-player object is placed based on the candidate position. The information processing system places one or more non-player object up to a first number based on a plurality of candidate positions.

### CROSS REFERENCE TO RELATED APPLICATION

This application claims priority to Japanese Patent Application No. 2025-074518, filed on April 28, 2025, the entire contents of which are incorporated herein by reference.

### FIELD

The present disclosure relates to one or more storage media, an information processing system, and a computer-implemented method for placing objects in a virtual space.

### BACKGROUND AND SUMMARY

There have been techniques for making objects appear in the field of a virtual space.

When placing objects in a virtual space, depending on the position where they are placed, a situation may arise where the objects placed appear fewer to the player than they actually are.

Therefore, the present application discloses one or more storage media, an information processing system, and computer-implemented method that can suppress the occurrence of situations where objects placed in a virtual space appear few.

(1) An example of one or more non-transitory computer-readable storage media having stored therein instructions that, when executed, cause one or more processors to execute information processing comprising: moving a player character in a field in a virtual space based on an operation input; generating and placing a non-player object based on a candidate position if at least one of a first condition and a second condition is satisfied, wherein the candidate position is set in a first range in the virtual space, the first range being set with respect to a first reference position, and the first reference position being set based on at least one of a position of the player character and a position of a virtual camera, the first condition is that no obstruction exists between the candidate position and a second reference position, the second reference position being set based on at least one of the position of the player character and the position of the virtual camera, and the second condition is that an obstruction exists between the candidate position and the second reference position, and where a third reference position, which is set based on at least one of the position of the player character and the position of the virtual camera, and the candidate position are both in a second range set in the field or are both in a third range set outside the second range; and generating and placing one or more non-player objects up to a first number based on a plurality of candidate positions.

With configuration (1) above, it is possible to suppress the occurrence of situations where non-player objects placed in the virtual space appear few.

(2)

In the configuration of the above (1), the second range may be a range representing an area enclosed by a wall placed in the field.

With configuration (2) above, it is possible to suppress the placement of non-player objects at positions on the opposite side of a wall as viewed from the player character.

(3)

In the configuration of the above (1) or (2), the information processing may comprise randomly setting a plurality of candidate positions in the first range.

With configuration (3) above, it is possible to suppress the occurrence of situations where non-player objects appear few while ensuring randomness for positions at which non-player objects appear.

(4)

In the configuration of the any one of above (1) to (3), the information processing may further comprise generating a non-player object excluding a case where the candidate position is inside an object in the virtual space.

With configuration (4) above, it is possible to suppress the placement of non-player objects at unnatural positions such as inside an object.

(5)

In the configuration of any one of above (1) to (4), the information processing may further comprise generating a non-player object excluding a case where the number of non-player objects in a fifth range including the candidate position is equal to or greater than a second number smaller than the first number.

With configuration (5) above, it is possible to reduce the possibility of non-player objects being unevenly distributed to a certain area of the field.

(6)

In the configuration of any one of above (1) to (5), the information processing may further comprise deleting a non-player object that satisfies a deletion condition, the deletion condition at least including a condition that the non-player object is outside a fourth range, the fourth range being set with respect to a fourth reference position, and the fourth reference position being set based on at least one of the position of the player character and the position of the virtual camera.

With configuration (6) above, by deleting non-player objects far away from the reference position, it is possible to increase the opportunity to place new non-player objects.

Then, as new non-player objects are placed, it is possible to suppress the occurrence of situations where non-player objects appear few.

(7)

In the configuration of the above (6), the deletion condition may further include a condition that a state where an obstruction exists between a non-player object and a fifth reference position continues for a first period of time or longer, the fifth reference position being set based on at least one of the position of the player character and the position of the virtual camera.

With configuration (7) above, by deleting non-player objects that have been obstructed by an obstruction for the first period of time, it is possible to increase the opportunity to place new non-player objects.

(8)

In the configuration of the above (6) or (7), the deletion condition may further include a condition that a position of the non-player object is outside the fourth range has not been subject to a rendering process for a second period of time or longer.

With configuration (8) above, by deleting non-player objects that have not been rendered for the second period of time, it is possible to increase the opportunity to place new non-player objects.

(9)

In the configuration of any one of above (6) to (8), the deletion condition may further include a condition that the player character has moved a first amount of movement or more since the generation of the non-player object. The information processing may further comprise controlling an orientation of the virtual camera based on an operation input.

With configuration (9) above, it is possible to suppress non-player objects from being deleted only because the orientation of the virtual camera is changed.

Note that the present specification discloses an example of an information processing apparatus and an information processing system for executing processing as set forth in (1) to (9) above. The present specification also discloses an example of a computer-implemented method for executing processing as set forth in (1) to (9) above.

With the storage media, the information processing system or the computer-implemented method set forth above, it is possible to suppress the occurrence of situations where objects placed in the virtual space appear few.

These and other features, aspects, and advantages of the subject matter described herein will become more apparent from the following detailed description when taken in conjunction with the accompanying drawings.

### BRIEF DESCRIPTION OF THE DRAWINGS

FIG. 1 is a diagram showing an example of a non-limiting game system;

FIG. 2 is a block diagram showing an example of an internal configuration of a non-limiting main body apparatus;

FIG. 3 is a diagram showing an example of a game image;

FIG. 4 is a diagram showing an example of the positional relationship between a reference position and a candidate position;

FIG. 5 is a diagram showing an example of the positional relationship between a reference position and a candidate position;

FIG. 6 is a diagram showing an example of the positional relationship between the player character and a candidate position;

FIG. 7 is a diagram showing an example of the relationship between positions of non-player objects already placed in the field and a candidate position;

FIG. 8 is a diagram showing an example of the positional relationship between

a reference position, the position of a non-player object, and the position of the virtual camera when making a determination for the second deletion condition;

FIG. 9 is a diagram showing an example of various data used for information processing in a non-limiting game system;

FIG. 10 is a flowchart showing an example of a flow of the game process executed by a non-limiting game system;

FIG. 11 is a sub-flowchart showing an example of a detailed flow of the object placement process of step S5 shown in FIG. 10; and

FIG. 12 is a sub-flowchart showing an example of a detailed flow of the object deletion process of step S6 shown in FIG. 10.

### DETAILED DESCRIPTION OF NON-LIMITING EXAMPLE EMBODIMENTS

### 1. Game System Configuration

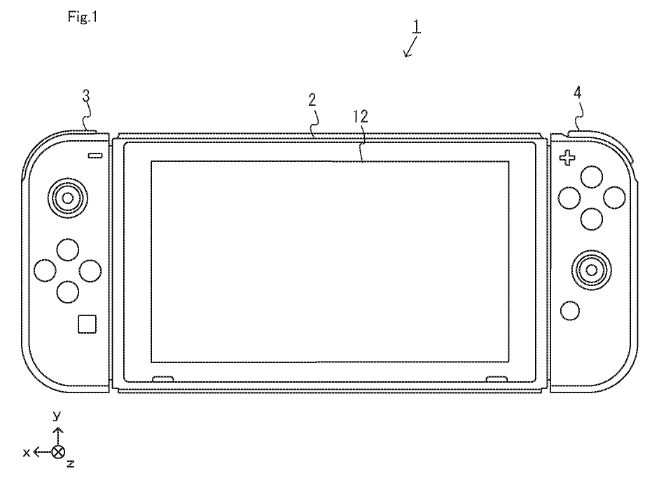

A game system according to an example of an exemplary embodiment is described below. FIG. 1 is a diagram showing an exemplary game system. An example of a game system 1 according to an exemplary embodiment includes a main body apparatus (an information processing apparatus; which functions as a game apparatus main body in an exemplary embodiment) 2, a left controller 3, and a right controller 4. The main body apparatus 2 is an apparatus for performing various processes (e.g., game processing) in the game system 1. The left controller 3 and the right controller 4 each include a plurality of buttons and an analog stick, as exemplary operation units through which a user performs input.

Each of the left controller 3 and the right controller 4 is attachable to and detachable from the main body apparatus 2. That is, a game system 1 can be used as a unified apparatus obtained by attaching each of the left controller 3 and the right controller 4 to the main body apparatus 2, or the main body apparatus 2, the left controller 3, and the right controller 4 may be separated from one another, when being used. It should be noted that hereinafter, the left controller 3 and the right controller 4 will occasionally be referred to collectively as a "controller".

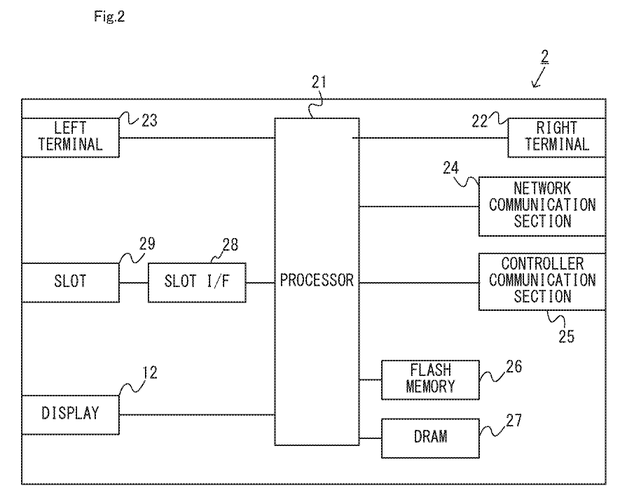

FIG. 2 is a block diagram showing an example of the internal configuration of the main body apparatus 2. As shown in FIG. 2, the main body apparatus 2 includes a processor 21. The processor 21 is an information processing section for executing various types of information processing (e.g., game processing) to be executed by the main body apparatus 2, and for example, includes a CPU (Central Processing Unit) and a GPU (Graphics Processing Unit). Note that a processor 21 may be configured only by a CPU, or may be configured by a SoC (System-on-a-Chip) that includes a plurality of functions such as a CPU function and a GPU function. The processor 21 executes an information processing program (e.g., a game program) stored in a storage section (specifically, an internal storage medium such as a flash memory 26, an external storage medium attached to the slot 29, or the like), thereby performing the various types of information processing.

Further, the main body apparatus 2 also includes a display 12. The display 12 displays an image generated by the main body apparatus 2. In an exemplary embodiment, the display 12 is a liquid crystal display device (LCD). The display 12, however, may be a display device of any type. The display 12 is connected to the processor 21. The processor 21 displays a generated image (e.g., an image generated by executing the above information processing) and/or an externally acquired image on the display 12.

Further, the main body apparatus 2 includes a left terminal 23, which is a terminal for the main body apparatus 2 to perform wired communication with the left controller 3, and a right terminal 22, which is a terminal for the main body apparatus 2 to perform wired communication with the right controller 4.

Further, the main body apparatus 2 includes a flash memory 26 and a DRAM (Dynamic Random Access Memory) 27 as examples of internal storage media built into the main body apparatus 2. The flash memory 26 and the DRAM 27 are connected to the processor 21. The flash memory 26 is a memory mainly used to store various data (or programs) to be saved in the main body apparatus 2. The DRAM 27 is a memory used to temporarily store various data used for information processing.

The main body apparatus 2 includes a slot 29. The slot 29 is so shaped as to allow a predetermined type of storage medium to be attached to the slot 29. The predetermined type of storage medium is, for example, a dedicated storage medium (e.g., a dedicated memory card) for a game system 1 and an information processing apparatus of the same type as the game system 1. The predetermined type of storage medium is used to store, for example, data (e.g., saved data of a game application or the like) used by the main body apparatus 2 and/or a program (e.g., a game program or the like) executed by the main body apparatus 2.

The main body apparatus 2 includes a slot interface (hereinafter abbreviated as "I/F") 28. The slot I/F 28 is connected to the processor 21. The slot I/F 28 is connected to the slot 29, and in accordance with an instruction from the processor 21, reads and writes data from and to the predetermined type of storage medium (e.g., a dedicated memory card) attached to the slot 29.

The processor 21 appropriately reads and writes data from and to the flash memory 26, the DRAM 27, and each of the above storage media, thereby performing the above information processing.

The main body apparatus 2 includes a network communication section 24. The network communication section 24 is connected to the processor 21. The network communication section 24 performs wired or wireless communication with an external apparatus via a network. In an exemplary embodiment, as a first communication form, the network communication section 24 connects to a wireless LAN and communicates with an external apparatus, using a method compliant with the Wi-Fi standard. Further, as a second communication form, the network communication section 24 wirelessly communicates with another main body apparatus 2 of the same type, using a predetermined communication method (e.g., communication based on a unique protocol or infrared light communication). It should be noted that the wireless communication in the above second communication form achieves the function of enabling so-called "local communication" in which the main body apparatus 2 can wirelessly communicate with another main body apparatus 2 placed in a closed local network area, and the plurality of main body apparatuses 2 communicate with each other directly or indirectly via an access point to transmit and receive data.

The main body apparatus 2 includes a controller communication section 25. The controller communication section 25 is connected to the processor 21. The controller communication section 25 wirelessly communicates with the left controller 3 and/or the right controller 4 detached from the main body apparatus 2. The communication method between the main body apparatus 2 and the left controller 3 and the right controller 4 is optional. In the exemplary embodiment, the controller communication section 25 performs communication compliant with the Bluetooth (registered trademark) standard with the left controller 3 and with the right controller 4.

The processor 21 is connected to the left terminal 23 and the right terminal 22. When performing wired communication with the left controller 3, a processor 21 transmits data to the left controller 3 via the left terminal 23 and also receives operation data from the left controller 3 via the left terminal 23. Further, when performing wired communication with the right controller 4, a processor 21 transmits data to the right controller 4 via the right terminal 22 and also receives operation data from the right controller 4 via the right terminal 22. As described above, in the exemplary embodiment, the main body apparatus 2 can perform both wired communication and wireless communication with each of the left controller 3 and the right controller 4.

It should be noted that, in addition to the elements shown in FIG. 2, the main body apparatus 2 includes a battery that supplies power and an output terminal for outputting images and audio to a display device (e.g., a television) separate from the display 12.

### 2. Overview Of Processing In Game System

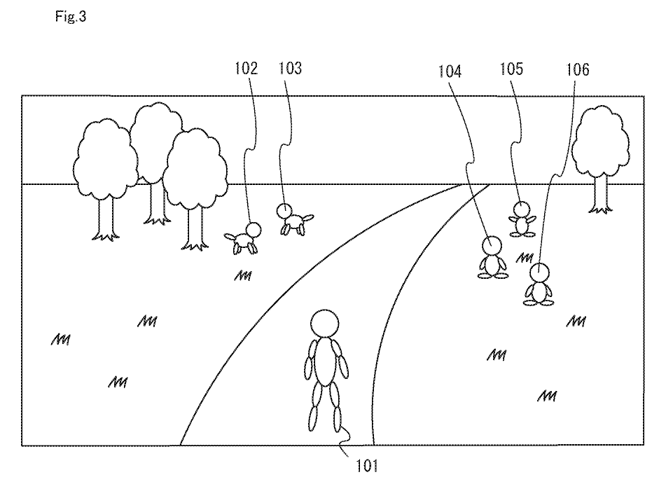

Referring to FIG. 3 to FIG. 8, an overview of the game process executed in the game system 1 will be described. In the exemplary embodiment, the game system 1 executes a game in which a player character that can be controlled by the player (also referred to as the user) appears in the field of a virtual space.

FIG. 3 is a diagram showing an example of a game image. In the exemplary embodiment, as shown in FIG. 3, the player character 101 is placed in a three-dimensional field, which is the virtual space. Note that in other embodiments, the virtual space may be a two-dimensional field rather than a three-dimensional field. In the exemplary embodiment, non-player objects (e.g., non-player objects 102 to 106 shown in FIG. 3) are placed in the virtual space. Note that while five non-player objects 102 to 106 are shown in FIG. 3, non-player objects may be placed not only in the field of view, but also outside the field of view, of the virtual camera used for generating the game image. The role of each non-player object in the game is arbitrary. For example, a non-player object may be an enemy character, a character that can be captured by the player character, or a character that can become an ally of the player character.

In the exemplary embodiment, the game system 1 places non-player objects in the field up to a predetermined upper-limit placeable number (e.g., 40). By setting an upper limit on the number of non-player objects that can be placed, it is possible to reduce the possibility that the processing load in the game process becomes excessive. Note that the specific value of the upper-limit placeable number is arbitrary.

In the exemplary embodiment, the game system 1 places non-player objects in the placeable range based on the reference position. In the exemplary embodiment, the reference position is the position of the player character. Note that in other embodiments, the position of the virtual camera that is set based on the position of the player character, for example, may be used as the reference position. Moreover, a position determined based on at least one of the position of the player character and the position of the virtual camera (e.g., a middle position therebetween), for example, may be used as the reference position. The placeable range is the area where non-player objects can be newly placed. For example, there is no need to restrict a non-player object from being positioned outside the placeable range after it has been placed.

In the exemplary embodiment, the placeable range is the area within an upper-limit placeable distance (e.g., 90 m) from the reference position. Note that the specific value of the upper-limit placeable distance is arbitrary. The placeable range may be an area of any shape and size determined based on the reference position. For example, in other embodiments, the placeable range may be set considering the orientation of the player character. For example, the placeable range may be set so that the placeable range forward of the player character is wider than the placeable range rearward of the player character. Also, for example, the range within a predetermined distance (this predetermined distance is shorter than the upper-limit placeable distance) from the reference position may be excluded from the placeable range. This reduces the possibility of non-player objects being placed at positions too close to the player character.

Now, even within the placeable range, non-player objects may possibly be placed at positions that are difficult to be displayed on the screen. A position that is difficult to be displayed on the screen is, for example, a position where, considering the game situation (such as the position of the player character) at that time, it is considered unlikely that the non-player object at that position will be displayed. Specifically, this includes positions in a cave when the player character is located outside the cave. When non-player objects are placed at such positions that are difficult to be displayed, the number of non-player objects may seem fewer than the number of non-player objects that are actually placed, thereby making the player feel there are only few non-player objects in the field. Therefore, in the exemplary embodiment, the non-player object placement process is executed so as to suppress the occurrence of situations where the number of non-player objects placed in the field appears few. The non-player object placement process in the exemplary embodiment will now be described.

In the exemplary embodiment, during the process of placing non-player objects, the game system 1 sets candidate positions to be candidates of positions for placing non-player objects. As will be described in detail later, a non-player object is placed based on a candidate position on the condition that the candidate position satisfies the placement condition to be described later.

In the exemplary embodiment, the process of setting a candidate position is executed on the condition that the number of non-player objects currently existing in the field is less than the upper-limit placeable number. This reduces the possibility that the number of non-player objects existing in the field will exceed the upper-limit placeable number. For example, the game system 1 determines whether the number of non-player objects existing in the field is less than the upper-limit placeable number at predetermined intervals (e.g., every frame), and a candidate position is set if it is determined to be less than the upper-limit placeable number. Note that the timing for executing the process of setting a candidate position during gameplay is arbitrary. For example, in other embodiments, the game system 1 may execute the process described above when a predetermined game event occurs, or may execute the process described above each time the player character has moved a predetermined distance.

In the exemplary embodiment, the game system 1 randomly sets a candidate position in the placeable range described above. For example, the position of a location randomly selected from among a plurality of locations pre-set in the field may be set as the candidate position. Note that the number of candidate positions set in a single candidate position setting process may be plural or may be one. Furthermore, the number of candidate positions may, for example, be a predetermined number or may be a number that is determined based on the number of non-player objects currently placed in the field. For example, the number of candidate positions may be determined based on the difference between the number of non-player objects placed in the field and the upper-limit placeable number. Note that the process of randomly setting candidate positions includes both a process where candidate positions are selected completely randomly and a process where candidate positions are selected with randomness based on a predetermined rule. For example, the predetermined rule may be such that positions forward of the player character are more likely to be selected than positions rearward of the player character. In other embodiments, candidate positions do not need to be selected randomly, and candidate positions may be set based on a predetermined rule, for example.

When a candidate position is set, the game system 1 determines whether the candidate position satisfies the placement condition. If the candidate position satisfies the placement condition, a non-player object is placed based on that candidate position on the condition that the exclusion condition to be described later is not satisfied. On the other hand, if the candidate position does not satisfy the placement condition, no non-player object is placed at the position based on that candidate position. In the exemplary embodiment, the first placement condition and the second placement condition to be described below are used as the placement condition. The placement conditions will be described below.

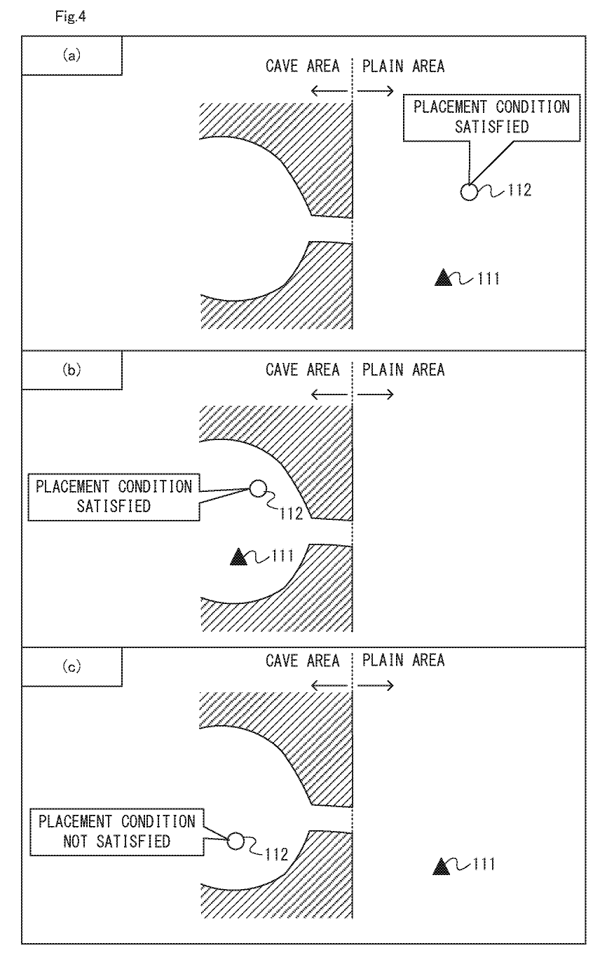

FIG. 4 is a diagram showing an example of the positional relationship between a reference position and a candidate position. Now, in the exemplary embodiment, there are caves in the field that are enclosed by walls formed by terrain objects, etc. Note that a cave does not need to be completely enclosed by walls on all sides, and the space in the cave and the space outside the cave may be continuous with each other so that the player character, etc., can move between inside and outside of the cave (see FIG. 4). In the exemplary embodiment, a plurality of areas are set in the field. The game system 1 stores area information that indicates which of the plurality of areas each location or range in the field belongs to. In the exemplary embodiment, the area in the cave (the cave area in the example shown in FIG. 4) is set as a different area from the area outside the cave (the plain area in the example shown in FIG. 4). Thus, in the exemplary embodiment, an extent in the field where it is difficult to see from the outside due to being enclosed by walls, or the like (such as in a cave as described above or in a building), is classified as an area that is different from other areas. Note that in the exemplary embodiment, an area is set so as not to overlap with another area. There may be some stretches in the field that do not belong to any of the areas.

In the exemplary embodiment, the first placement condition is that the reference position and the candidate position are located in the same area. (a) shown in FIG. 4 is a situation where the reference position 111 and the candidate position 112 are both located in the plain area, and (b) shown in FIG. 4 is a situation where the reference position 111 and the candidate position 112 are both located in the cave area. In these situations, the candidate position 112 satisfies the first placement condition. The situation (c) shown in FIG. 4 is a situation where the reference position 111 is located in the plain area and the candidate position 112 is located in the cave area. In such a situation, the candidate position 112 does not satisfy the first placement condition. Note that, although not shown, also in the situation where the reference position 111 is located in the cave area and the candidate position 112 is located in the plain area, the candidate position 112 does not satisfy the first placement condition.

In the exemplary embodiment, if the candidate position does not satisfy the first placement condition, the placement of a non-player object based on that candidate position is not performed, unless the second placement condition to be described later is satisfied. Therefore, according to the exemplary embodiment, it is possible to reduce the possibility of a non-player object being placed in an area different from the current reference position. For example, when the player character is located in the plain area, non-player objects at positions in the cave area are unlikely to be displayed on the screen, even if the positions are in the placeable range. Using the first placement condition, it is possible to reduce the possibility of a non-player object being placed at such a position. Note that one method for preventing a non-player object from being placed at a position that is difficult to be displayed, such as a position in the cave area, where the player character is located in the plain area, may be to design the field in advance taking the placeable range into consideration. An example of such a method is to design the field in advance so that a cave area is not located near a plain area. In contrast, according to the exemplary embodiment, it is possible, regardless of the shape of the field, to reduce the possibility of a non-player object being placed at a position that is difficult to be displayed.

In the exemplary embodiment, the game system 1 determines the first placement condition by referring to the area information described above. Specifically, if the area associated with the reference position and the area associated with the candidate position are the same in the area information, the game system 1 determines that this candidate position satisfies the first placement condition. On the other hand, if the area associated with the reference position and the area associated with the candidate position are different in the area information, it is determined that this candidate position does not satisfy the first placement condition.

Note that the specific method for determining the first placement condition is arbitrary. For example, in other embodiments, the game system 1 may not store the area information. In this case, the game system 1 may extend lines in multiple directions (e.g., the four directions of front, back, left, and right) from the reference position and the candidate position, and determine, for each of the reference position and the candidate position, whether they are in an area enclosed by walls based on whether the lines hit the walls in the field. If only one of the reference position and the candidate position is determined to be in an area enclosed by walls, the candidate position may be determined as not satisfying the first placement condition. Also by using this method, it is possible to determine whether the reference position or the candidate position is located in a cave or in a building.

Note that, if whether or not a non-player object can be placed based on a candidate position were determined based only on the first placement condition, non-player objects would not be placed based on candidate positions set in areas different from where the reference position is. Now, for example, consider a situation where the player character moves from a position in a cave area to a position in a plain area. In this situation, if the determination were made based only on the first placement condition, immediately after the player character moves from the cave area to the plain area, non-player objects would exist in the cave area the player character moves out of but no non-player objects would exist in the plain area the player character moves into, thereby potentially creating a situation where non-player objects appear few. Therefore, in order to reduce such a possibility, in the exemplary embodiment, the second placement condition is set in addition to the first placement condition.

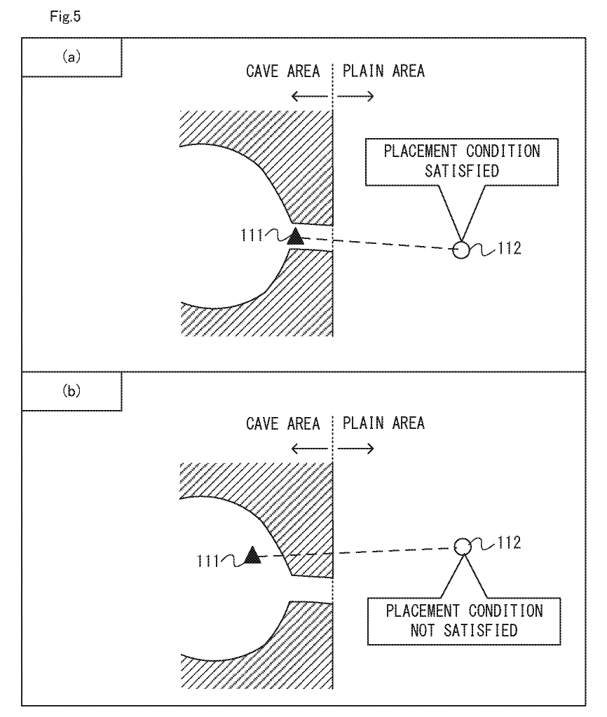

In the exemplary embodiment, the second placement condition is that no obstruction exists between the reference position and the candidate position. FIG. 5 is a diagram showing an example of the positional relationship between a reference position and a candidate position. (a) shown in FIG. 5 is a situation where the reference position 111 is near the entrance of a cave area, and the candidate position 112 is in a plain area. It is assumed in this situation that there is no obstruction between the reference position 111 and the candidate position 112. Note that obstructions are objects such as walls, rocks, or buildings placed in the field, for example. An object to be an obstruction may be a terrain object or another object placed on a terrain object. In the situation shown in (a) of FIG. 5, the candidate position 112 satisfies the second placement condition. (b) shown in FIG. 5 is a situation where the reference position 111 is located at a position away from the entrance of the cave area, and the candidate position 112 is in the plain area. It is assumed in this situation that an obstruction (here, a wall of the cave) exists between the reference position 111 and the candidate position 112. In the situation shown in (b) of FIG. 5, the candidate position 112 does not satisfy the second placement condition.

In the exemplary embodiment, the game system 1 makes a determination for the second placement condition by using a ray-cast method. Specifically, the game system 1 determines whether a straight line (also called a ray) extending from the candidate position to the reference position hits an obstruction. If the straight line does not hit an obstruction, the candidate position is determined to satisfy the second placement condition, and if the straight line hits an obstruction, the candidate position is determined as not satisfying the second placement condition.

In the exemplary embodiment, if a candidate position satisfies the second placement condition, a non-player object is placed based on that candidate position, regardless of whether the candidate position satisfies the first placement condition. As described above, if a candidate position satisfies the first placement condition, a non-player object is placed based on that candidate position, regardless of whether the candidate position satisfies the second placement condition. Thus, in the exemplary embodiment, when a reference position and a candidate position are located in the same area and when no obstruction exists between a reference position and a candidate position, a non-player object is placed based on the candidate position (meaning that a non-player object is placed in either of these two cases, but not meaning that a non-player object is placed only when both conditions are met). Thus, non-player objects are placed at positions that are easy to be displayed on the screen, thereby reducing the possibility of non-player objects being placed at positions that are difficult to be displayed. By setting the second placement condition, it is possible to reduce the possibility described above even in situations where the player character moves between areas, for example.

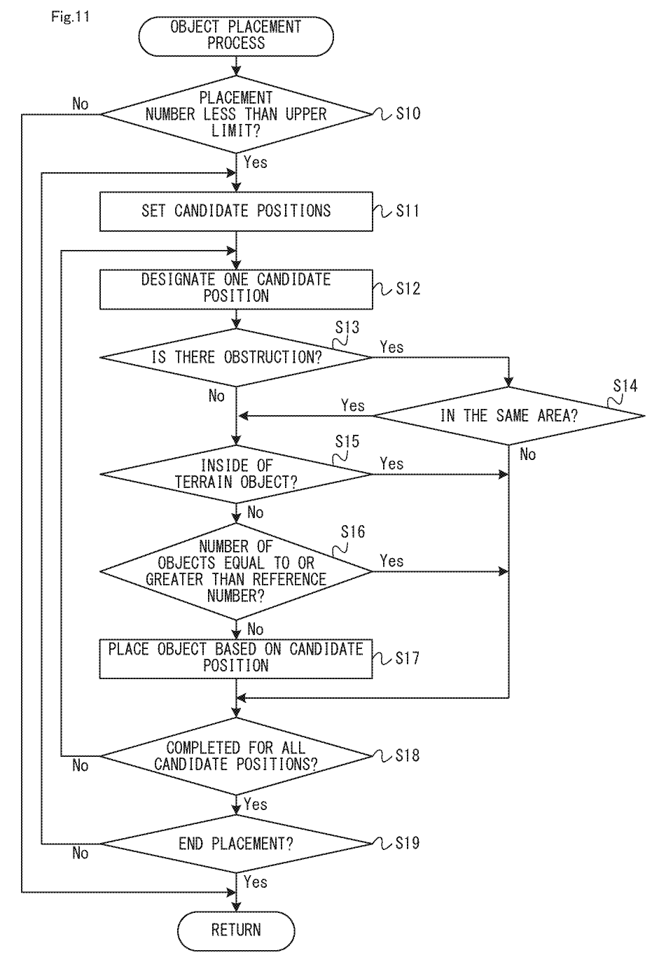

Note that while the second placement condition was described after the first placement condition for clarity of explanation, the order in which the game system 1 makes determinations for the first placement condition and the second placement condition is arbitrary. For example, in the exemplary embodiment, the game system 1 may first make a determination on a candidate position for the second placement condition and, if the second placement condition is not satisfied, then make a determination on the candidate position for the first placement condition (see FIG. 11). Note that also for the exclusion condition and the deletion condition to be described later, the order in which the game system 1 makes determinations for the conditions is arbitrary.

Note that in other embodiments, as the placement condition, either one of the first placement condition and the second placement condition may be used, or conditions other than the first placement condition and the second placement condition may be used.

In the exemplary embodiment, the exclusion condition is set for candidate positions. The exclusion condition is a condition for determining whether or not to exclude a candidate position from being used for placing a non-player object. If a candidate position satisfies the exclusion condition, a non-player object is not placed at a position based on that candidate position, even if the candidate position satisfies the placement condition. That is, a candidate position that satisfies the placement condition is used for placing a non-player object on the condition that the candidate position does not satisfy the exclusion condition. In the exemplary embodiment, two conditions to be described below are used as the exclusion condition.

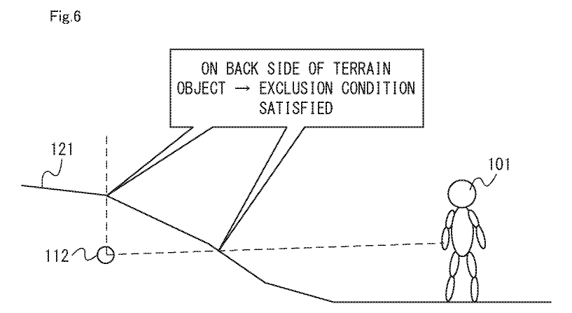

The first exclusion condition is that the candidate position is inside a terrain object in the virtual space. FIG. 6 is a diagram showing an example of the positional relationship between the player character and a candidate position. As shown in FIG. 6, if the candidate position 112 is located inside a terrain object 121, which represents the ground surface, the candidate position 112 satisfies the first exclusion condition. In the exemplary embodiment, the game system 1 makes a determination for the first exclusion condition by using a ray-cast method, for example. Specifically, where a straight line is extended from the candidate position 112 to the reference position (the position of the player character 101 in FIG. 6), the game system 1 determines whether the position that is first hit by the straight line is on the back side of the terrain object (specifically, a polygon of the terrain object) (see FIG. 6). Also, where a straight line is extended in the upward direction from the candidate position 112, the game system 1 determines whether the position that is first hit by the straight line is on the back side of the terrain object (see FIG. 6). Then, if at least one of the positions hit by the straight lines is on the back side of the terrain object, it is determined that the first exclusion condition is satisfied; and if neither of the positions hit by the straight lines is on the back side of the terrain object, it is determined that the first exclusion condition is not satisfied. Note that when making a determination for the first exclusion condition, the game system 1 may determine whether the candidate position is at a position inside an object, not only for a terrain object as shown in FIG. 6 but also for various objects placed on the terrain object. As described above, with the first exclusion condition, it is possible to reduce the possibility of a non-player object being placed based on a candidate position located inside an object.

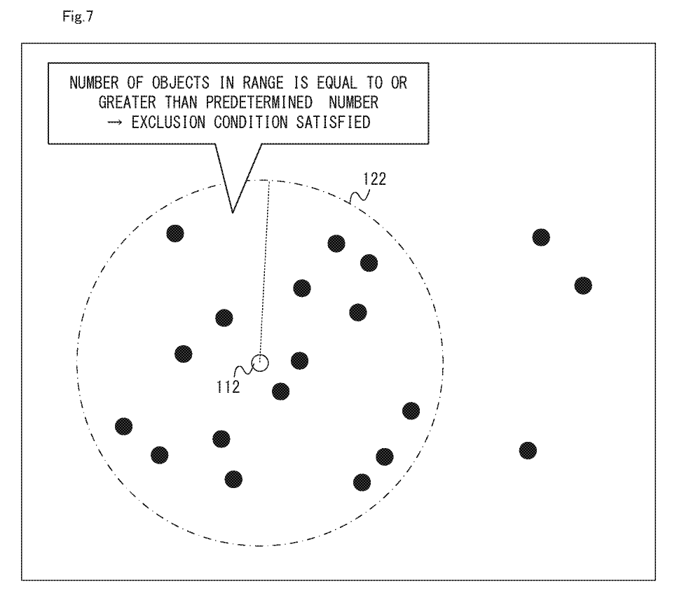

The second exclusion condition is that the number of non-player objects in a predetermined determination range including the candidate position is equal to or greater than a predetermined reference number. FIG. 7 is a diagram showing an example of the relationship between positions of non-player objects existing in the field and the candidate position. In FIG. 7, black circles represent the positions of non-player objects already placed in the field. In the exemplary embodiment, the determination range (the range 122 within the one-dot-chain line in FIG. 7) is the area within a predetermined distance from the candidate position. Note that the determination range may be an arbitrary range based on the candidate position. For example, the predetermined distance may be a distance (e.g., 20 m) shorter than the upper-limit placeable distance (e.g., 90 m). The reference number may be any number (e.g., 15) smaller than the upper-limit placeable number described above. It is assumed in the example shown in FIG. 7, the number of non-player objects in the determination range 122 based on the candidate position 112 is 16, which is greater than the reference number. In this case, the second exclusion condition is satisfied. With the second exclusion condition described above, it is possible to reduce the possibility of non-player objects being unevenly distributed to a certain area of the field.

In the exemplary embodiment, if a candidate position satisfies at least one of the first exclusion condition and the second exclusion condition, a non-player object is not placed at the position based on that candidate position. Therefore, if a candidate position satisfies at least one of the first placement condition and the second placement condition, and does not satisfy either one of the first exclusion condition and the second exclusion condition, a non-player object is placed based on that candidate position.

Note that in other embodiments, only one of the first exclusion condition and the second exclusion condition may be used as the exclusion condition, or other conditions different from the first exclusion condition and the second exclusion condition may be used.

Note that, when a plurality of candidate positions are set, the game system 1 makes a determination for the placement condition and the exclusion condition for each of the candidate positions.

In the exemplary embodiment, when placing a non-player object based on a candidate position, the game system 1 places one or more non-player objects. The game system 1 may, for example, determine the number of non-player objects to be newly placed by any method, provided the total number of non-player objects after the placement process does not exceed the upper-limit placeable number. Note that the game system 1 places non-player objects up to the upper-limit placeable number, and does not always need to place non-player objects so that the number of non-player objects placed is equal to the upper-limit placeable number. The number of non-player objects to be newly placed may be determined randomly or according to a predetermined rule considering, for example, the game situation, etc. Thus, in the exemplary embodiment, a plurality of non-player objects may be placed based on one candidate position. Thus, the number of candidate positions to be set can be kept low relative to the number of non-player objects placed. Also, a plurality of non-player objects can be made to appear as if they were forming a group or groups.

While the position where a non-player object is placed is determined based on a candidate position, it does not always need be the exact same position as the candidate position. For example, the game system 1 may place a non-player object at a position within a predetermined distance from the candidate position.

Note that in the exemplary embodiment, as a result of making a determination for the placement condition and the exclusion condition for each of the candidate positions set, there may be cases where no non-player object is placed or few non-player objects are placed because no candidate positions or few candidate positions satisfy the conditions. In such cases, in the exemplary embodiment, the game system 1 may set candidate positions again and make a determination for the placement condition and the exclusion condition for the newly set candidate positions. For example, the game system 1 may repeat setting candidate positions and making a determination for the placement condition and the exclusion condition for the candidate positions until a predetermined termination condition is satisfied. Note that the specific content of the termination condition is arbitrary. For example, the termination condition may be that the process of setting candidate positions and making determinations for the conditions for the candidate positions has been repeated a predetermined number of times, or that a predetermined number or more of non-player objects have been placed.

In the exemplary embodiment, the game system 1 executes the placement process described above, and also executes the deletion process of deleting a non-player object in the field under predetermined conditions. As will be described in detail later, with the deletion process, a non-player object located at a position that is difficult to be displayed is deleted. In the exemplary embodiment, the number of non-player objects in the field dynamically changes through the placement process and the deletion process. In the exemplary embodiment, since the number of non-player objects in the field is reduced by the deletion process, the difference between the number of non-player objects in the field and the upper-limit placeable number increases, thereby increasing the opportunity to place new non-player objects by the placement process. The deletion process will be described below.

In the exemplary embodiment, the game system 1 determines, at predetermined intervals (e.g., every frame), whether the deletion condition is satisfied for each non-player object in the field. Then, non-player objects for which the deletion condition is satisfied are deleted from the field. Note that the timing for executing the process of making a determination for the deletion condition during gameplay is arbitrary. For example, in other embodiments, the game system 1 may execute the process described above when a predetermined game event occurs, or may execute the process described above each time the player character has moved a predetermined distance.

In the exemplary embodiment, the deletion condition includes the condition that the position of a non-player object is outside a predetermined first reference distance from the reference position (hereinafter referred to as the "first deletion condition"). While the first reference distance is arbitrary, the first reference distance is a distance (e.g., 100 m) equal to or greater than the upper-limit placeable distance (e.g., 90 m). By setting the first reference distance longer than the upper-limit placeable distance, it is possible to reduce the possibility that a non-player object is deleted by satisfying the first deletion condition immediately after the non-player object is placed. In the exemplary embodiment, if a non-player object satisfies the first deletion condition, it is deleted from the field regardless of whether the non-player object satisfies the second deletion condition to be described later. Note that the content of the first deletion condition is arbitrary and not limited to the above. For example, in other embodiments, the first deletion condition may be any condition that is related to the relationship between the position of the non-player object and the reference position. For example, the first deletion condition may be that the position of the non- player object continues to be in the range outside the first reference distance from the reference position for a predetermined period of time. The range used for the first deletion condition may be a range of any shape and size defined based on the reference position.

Note that the game system 1 may display, as being semi-transparent, non-player objects that do not satisfy the first deletion condition but are at a distance close to the first reference distance from the reference position. For example, the game system 1 may display, as being semi-transparent, non-player objects at a distance equal to or greater than a predetermined distance from the reference position. This predetermined distance may be the same value as the upper-limit placeable distance described above, for example. According to the above, when a non-player object is deleted by satisfying the first deletion condition, even if the non-player object has been displayed on the screen prior to deletion, the non-player object has been displayed as being semi-transparent, thereby allowing the deletion to appear natural. In other embodiments, the transparency of a non-player object may increase as the distance from the reference position increases. Thus, the deletion of a non-player object based on satisfying the first deletion condition can be made to appear more natural.

As described above, in the exemplary embodiment, non-player objects in the field can be deleted based on the first deletion condition. Here, if the deletion process were executed based only on the first deletion condition, non-player objects located within the first reference distance from the reference position would not be deleted, even if they were placed at positions that are difficult to be displayed on the screen. For example, even if the player character moves after a non-player object is placed, causing the two to be located in different areas, the non-player object may not be deleted. If a non-player object at a position that is difficult to be displayed remains to exist, the opportunity to place new non-player objects by the placement process may decrease. As a result, the number of non- player objects placed at positions that are easy to be displayed becomes few, which may create a situation where the non-player objects placed in the field appear few.

Therefore, in the exemplary embodiment, the game system 1 executes the deletion process based on the second deletion condition in addition to the first deletion condition. In the exemplary embodiment, the second deletion condition includes first to fourth sub-conditions. As will be described in detail later, in the exemplary embodiment, even if a non-player object does not satisfy the first deletion condition, the non-player object may be deleted depending on whether the first to fourth sub-conditions of the second deletion condition are satisfied.

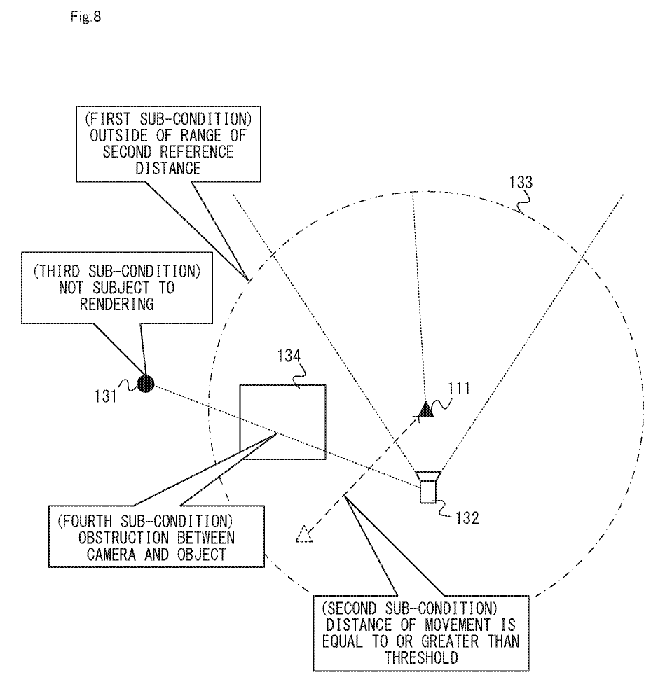

FIG. 8 is a diagram showing an example of the positional relationship between the reference position, the position of a non-player object, and the position of the virtual camera when making a determination for the second deletion condition. In FIG. 8, a position 131 is the position of a non-player object for which a determination is made for the deletion condition. Note that in the example shown in FIG. 8, the reference position 111 is the position of the player character. In the exemplary embodiment, the game system 1 controls the position and orientation of a virtual camera 132 following the movement of the player character so that the player character is included in the field of view. The game system 1 also controls the position and orientation of the virtual camera 132 in response to an operation input by the player so that the virtual camera 132 rotates around the player character while facing the player character.

In the exemplary embodiment, the first sub-condition is that the position of the non-player object is outside a range 133 of a predetermined second reference distance from the reference position (see FIG. 8). The range 133 of the second reference distance is a range within which a non-player object is not deleted by the deletion process. While the second reference distance is arbitrary, the second reference distance is, for example, a distance (e.g., 40 m) shorter than the first reference distance (e.g., 100 m) described above. In the example shown in FIG. 8, since the position 131 of the non-player object is outside the range 133 of the second reference distance, the first sub-condition is satisfied. By setting the first sub-condition, it is possible to prevent non-player objects located at positions close to the reference position from being deleted. Note that in other embodiments, the range 133 used for the first sub-condition does not need to be limited to a circular range but may be of any shape. The first sub-condition may be any condition relating to the relationship between the position of a non-player object and the reference position. For example, the first sub-condition may be that the position of the non-player object continues to be outside the range of the second reference distance from the reference position for a predetermined period of time. The range used for the first sub-condition may be a range of any shape and size defined based on the reference position.

The second sub-condition is that the distance of movement of the player character since the non-player object was generated is a predetermined distance (e.g., 10 m) or more (see FIG. 8). Note that as the distance of movement of the player character, the game system 1 may use the straight-line distance between the position of the player character at the time of generation of the non-player object and the current position of the player character, or the length of the path along which the player character has moved since the time of generation of the non-player object to the current point in time. Note that the second sub-condition may be any condition related to the amount of movement of the player character since the generation of the non-player object reaching a predetermined amount of movement or more. For example, in other embodiments, the second sub-condition may be that the cumulative amount of time that the player character has moved since the generation of the non-player object is a predetermined amount of time or more.

Here, if the second sub-condition were not set and the deletion process were executed based on the first, third, and fourth sub-conditions, a non-player object could potentially be deleted because the first, third, and fourth sub-conditions are satisfied as the player moved the virtual camera 132 even if the player character was not moved. For this, in the exemplary embodiment, by setting the second sub-condition, it is possible to reduce the possibility of a non-player object being deleted merely because the player performs an operation input to move the virtual camera 132.

The third sub-condition is that the state where a non-player object is not subject to the rendering process continues for a predetermined first reference period of time or longer (see FIG. 8). The length of the first reference period is arbitrary, and is one second, for example. In the example shown in FIG. 8, since the position 131 of the non-player object is outside the field of view of the virtual camera 132, if the state shown in FIG. 8 continues for the first reference period of time or longer, the third sub-condition is satisfied. Another example where a non-player object satisfies the third sub-condition is when the non-player object is not rendered by being obstructed by another object. A determination for the third sub-condition can be made every frame based on whether the non-player object was actually rendered in the preceding frame. Note that a determination for the third sub-condition can be made based simply on whether the non-player object is in the field of view of the virtual camera 132. By setting the third sub-condition, it is possible to suppress deletion of a non-player object that is displayed on the screen.

The fourth sub-condition is that the state where an obstruction exists between the position of a non-player object and the virtual camera 132 for a predetermined second reference period of time or longer (see FIG. 8). The length of the second reference period of time is arbitrary, and may be, for example, the same length as the first reference period of time (e.g., one second). In the example shown in FIG. 8, since an object 134 acting as an obstruction exists between the position 131 of the non-player object and the virtual camera 132, if the state shown in FIG. 8 continues for the second reference period of time or longer, the fourth sub-condition is satisfied. Now, consider, for example, a case where the player performs an operation of changing the orientation of the virtual camera from one orientation to another, and then returning the virtual camera to the original orientation after an amount of time slightly longer than the first reference period of time has elapsed. In this case, if the fourth sub-condition were not set, a non-player object that was in the field of view of the virtual camera at the original orientation thereof might be deleted because the third sub-condition would be satisfied. Then, the player might experience a sense of awkwardness as if the non-player object was suddenly deleted when the player changes back the orientation of the virtual camera. For this, by setting the fourth sub-condition, it is possible to reduce the possibility of a non-player object being deleted in that manner because as long as no obstruction exists between the virtual camera and the non-player object, the fourth sub-condition will not be satisfied even if the third sub-condition is satisfied. If an obstruction exists between the virtual camera and the non-player object, the third sub-condition and the fourth sub-condition may both be satisfied, but in such a case, it is believed that the player is unlikely to experience such a sense of awkwardness as described above because the non-player object is obstructed by the obstruction.

In the exemplary embodiment, the method for making a determination for the second deletion condition using the first to fourth sub-conditions varies depending on the distance from the reference position to the non-player object. Specifically, if the distance is equal to or greater than a predetermined threshold reference distance, the second deletion condition is satisfied on the condition that the non-player object satisfies all of the first sub-condition to the fourth sub-condition, and the non-player object is deleted. On the other hand, if the distance is less than the threshold reference distance, the fourth sub-condition is not applied, so that the non-player object is deleted as the second deletion condition is satisfied on the condition that the non-player object satisfies all of the first sub-condition to the third sub-condition. Note that while the threshold distance may be of any value, it is, for example, a value (e.g., 70 m) smaller than the first reference distance (e.g., 100 m) and larger than the second reference distance (e.g., 40 m). The reason for varying the determination method using the second deletion condition based on the above distance is that when the distance is relatively large, the player is unlikely to experience such a sense of awkwardness as described above even if a non-player object is deleted in response to the player performing an operation of changing, and then changing back, the orientation of the virtual camera. Note that in other embodiments, the non-player object may be deleted on the condition that all of the first sub-condition to the fourth sub-condition are satisfied, regardless of the distance from the reference position to the position of the non-player object.

In other embodiments, the second deletion condition may include only some of the first sub-condition to the fourth sub-condition, or may include other conditions different from the first sub-condition to the fourth sub-condition.

As described above, in the exemplary embodiment, non-player objects in the field are deleted by the deletion process. Thus, since at least a number of non-player objects equal to the number of deleted non-player objects can be newly placed by the placement process, it can be said that it is possible, with the deletion process, to increase the opportunity to place non-player objects. Now, in the exemplary embodiment, when a non-player object located at a position difficult to be displayed is deleted by the deletion process, a new non-player object is placed at a position that is easy to be displayed by the placement process thereafter. Therefore, it is possible to suppress situations where non-player objects appear few to the player.

### 3. Specific Example Of Process In Game System

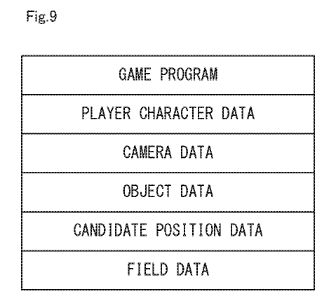

Next, with reference to FIG. 9 to FIG. 12, a specific example of an information process in the game system 1 will be described.

FIG. 9 is a diagram showing an example of various data used for information processing in the game system 1. The various data shown in FIG. 9 are stored in a storage medium that can be accessed by the main body apparatus 2 (e.g., the flash memory 26, the DRAM 27, and/or a memory card inserted in the slot 29, etc.).

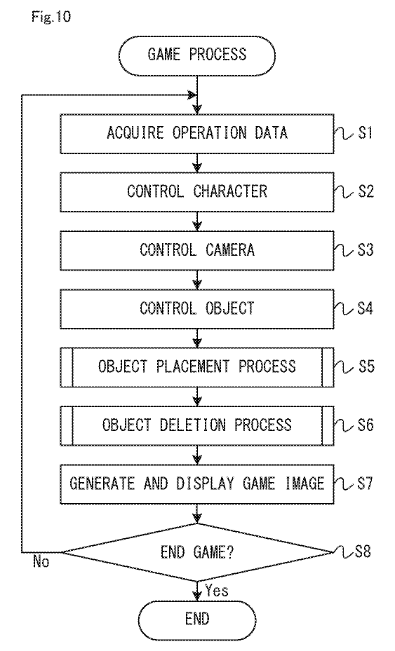

As shown in FIG. 9, the game system 1 stores a game program. The game program is a game program for executing the game process (see FIG. 10 to FIG. 12) in the exemplary embodiment. The game system 1 also stores player character data, camera data, object data, candidate position data, field data, etc.

The player character data indicates information about the player character. For example, the player character data includes data indicating the position and orientation of the player character, and data indicating the status of the player character (e.g., HP, items possessed, etc.). In the exemplary embodiment, the player character data also includes data indicating the history of the position of the player character. The data indicating the position history includes data indicating the positions of the player character from a predetermined amount of time ago up to the current point in time, for example.

The camera data indicates information about the virtual camera. For example, the camera data includes data indicating the position, orientation, and field of view, etc., of the virtual camera.

The object data indicates information about objects in the field, such as non-player objects. The object data is stored in a storage medium for each object. For example, the object data about a non-player object includes data indicating the position and orientation of the non-player object, and data indicating the timing at which the non-player object was generated (specifically, the timing at which it was placed in the field by the placement process).

The candidate position data indicates candidate positions described above. The field data indicates information about the field. In the exemplary embodiment, the field data includes data indicating the position and shape of terrain objects in the virtual space, and data of area information described above.

FIG. 10 is a flowchart showing an example of a flow of the game process executed by the game system 1. The game process starts in response to the game being started during execution of the game program described above. Note that in the exemplary embodiment, at the start of the game process, data indicating the state at the start of the game are stored as the player character data, the camera data, the object data, and the field data.

Note that in the exemplary embodiment, the processor 21 of the main body apparatus 2 executes the game program stored in the game system 1 to execute the processes of the steps shown in FIG. 10 to FIG. 12. However, in other embodiments, some of the processes of the steps may be executed by a processor (e.g., a dedicated circuit, etc.) other than the processor 21. Note that if the game system 1 is capable of communicating with another information processing apparatus (e.g., a server), some of the processes of the steps shown in FIG. 10 to FIG. 12 may be executed on the other information processing apparatus. The processes of the steps shown in FIG. 10 to FIG. 12 are merely illustrative, and the order of steps to be performed may be switched around or other processes may be executed in addition to (or instead of) the processes of the steps, as long as similar results are obtained.

The processor 21 executes the processes of the steps shown in FIG. 10 to FIG. 12 using a memory (e.g., the DRAM 27). That is, the processor 21 stores the information (in other words, data) obtained by each process step in the memory and reads out the information from the memory to use the information in a subsequent process step.

In step S1 shown in FIG. 10, the processor 21 acquires operation data indicating an operation input by the player. That is, the processor 21 acquires operation data received from the controller via the controller communication section 25 and/or the terminals 22 and 23, and stores the operation data in the memory. The process of step S2 is executed, following step S1.

In step S2, the processor 21 controls the action of the player character based on the operation data acquired in step S1. For example, the processor 21 determines the position and orientation of the player character at the current frame by determining the direction of movement of the player character based on the operation data. For example, the processor 21 causes the player character to perform an action based on the operation data. Note that during one iteration of step S2, the processor 21 controls the player character to progress the action for one frame time. By repeatedly executing the process of step S2 for a plurality of frames, the player character performs a series of movements of the action. The processor 21 updates the player character data stored in the memory so that the updated data indicates the new position, orientation, posture, etc., of the player character determined in step S2. The process of step S3 is executed, following step S2.

In step S3, the processor 21 controls the virtual camera. For example, the processor 21 controls the position and orientation of the virtual camera such that the virtual camera follows the player character from behind. When an operation input by the player related to the virtual camera is received, the virtual camera is controlled to change its position and orientation according to the operation input. Note that the specific method for controlling the virtual camera is arbitrary and not limited to the above. The position and orientation of the virtual camera may be determined by any method based on the position of the player character. The position and orientation of the virtual camera may be determined by any method where the position and orientation change in response to an operation input by the player. The processor 21 updates the camera data stored in the memory so that the updated data indicates the position and orientation newly determined as described above.

### The process of step S4 is executed, following step S3.

In step S4, the processor 21 controls the actions of other objects located in the virtual space, other than the player character. The actions of non-player objects described above are controlled based on rules predetermined in the game program. Thus, each non-player object performs an action such as moving around or jumping in the field, for example. Note that the specific method for controlling non-player objects is arbitrary. Non-player objects may simply be placed in the field, and the processor 21 does not need to control them to move or perform predetermined actions. Note that during one iteration of step S4, the processor 21 controls each non-player object to progress the action for one frame time. By repeatedly executing the process of step S4 for a plurality of frames, the non-player object performs a series of movements of the action. The processor 21 updates the object data stored in the memory so that the updated data indicates the new position, orientation, posture, etc., of each object determined in step S4. The process of step S5 is executed, following step S4.

In step S5, the processor 21 executes an object placement process to place new non-player objects in the field. The details of the object placement process in step S5 will now be described with reference to FIG. 11.

FIG. 11 is a sub-flowchart showing an example of a detailed flow of the object placement process of step S5 shown in FIG. 10. In the object placement process shown in FIG. 11, first, in step S10, the processor 21 determines whether the number of non-player objects in the field is less than the upper-limit placeable number. The determination in step S10 is made based on the object data stored in the memory. If the determination result from step S10 is affirmative, the process of step S11 is executed. On the other hand, if the determination result from step S10 is negative, the processor 21 ends the object placement process.

In step S11, the processor 21 sets candidate positions for placing non-player objects. In the exemplary embodiment, one or more candidate positions are set randomly according to the method described in 2. Overview Of Processing In Game System] above. The processor 21 stores, in the memory as the candidate position data, data indicating the candidate positions that have been set. The process of step S12 is executed, following step S11 is executed.

In step S12, the processor 21 designates one candidate position from among the candidate positions set in step S11 that has not been subject to the process of making determinations for the placement condition and the exclusion condition (steps S13 to S16). The process of step S13 is executed, following step S12 is executed.

In step S13, the processor 21 determines whether an obstruction exists between the candidate position designated in step S12 and the reference position. The determination of step S13 is a determination for the second placement condition described above. The processor 21 makes the determination of step S13 according to the method described in 2. Overview Of Processing In Game System] above based on the data of the reference position based on the player character data, the candidate position data, and the field data. If the determination result from step S13 is affirmative, the process of step S14 is executed. On the other hand, if the determination result from step S13 is negative, the process of step S15 is executed.

In step S14, the processor 21 determines whether the candidate position designated in step S12 and the reference position exist in the same area. The determination of step S13 is a determination for the first placement condition described above. The processor 21 makes the determination of step S14 according to the method described in 2. Overview Of Processing In Game System] above based on the data of the reference position based on the player character data, the candidate position data, and data of area information included in the field data. If the determination result from step S14 is affirmative, the process of step S15 is executed. On the other hand, if the determination result from step S14 is negative, the process of step S18 is executed. In this case, the first placement condition and the second placement condition are both not satisfied, and therefore the placement of a non-player object based on the candidate position (step S17) is not performed.

In step S15, the processor 21 determines whether the candidate position designated in step S12 is a position inside a terrain object. The determination of step S15 is a determination for the first exclusion condition described above. The processor 21 makes the determination of step S15 according to the method described in 2. Overview Of Processing In Game System] above based on the candidate position data, and the data of terrain objects included in the field data. If the determination result from step S15 is negative, the process of step S16 is executed. On the other hand, if the determination result from step S15 is affirmative, the process of step S18 is executed. In this case, the first exclusion condition is satisfied, and therefore the placement of a non-player object based on the candidate position (step S17) is not performed.

In step S16, the processor 21 determines whether the number of non-player objects in the determination range including the candidate position designated in step S12 is equal to or greater than a reference number. The determination of step S15 is a determination for the second exclusion condition described above. The processor 21 makes the determination of step S16 based on the candidate position data, and the position data of non-player objects included in the object data. If the determination result from step S16 is negative, the process of step S17 is executed. On the other hand, if the determination result from step S16 is affirmative, the process of step S18 is executed. In this case, the second exclusion condition is satisfied, and therefore the placement of a non-player object based on the candidate position (step S17) is not performed.

In step S17, the processor 21 places a non-player object in the field based on the candidate position designated in step S12. In the exemplary embodiment, the processor 21 newly places one or more non-player object at the position based on the candidate position according to the method described in 2. Overview Of Processing In Game System] above. The processor 21 updates the object data stored in the memory so that the object data includes data indicating the positions of the newly placed non-player objects. The process of step S18 is executed, following step S17 is executed.

In step S18, the processor 21 determines whether the process of making determinations for the placement condition and the exclusion condition (steps S13 to S16) has been completed for all candidate positions set in step S11. If the determination result from step S18 is negative, the process of step S12 is executed again, and a candidate position for which the determination process has not been completed is designated when the process of step S12 is executed again. On the other hand, if the determination result from step S18 is affirmative, the process of step S19 is executed.

In step S19, the processor 21 determines whether or not to end the non-player object placement process. For example, this determination is made based on whether the process of step S11 has been executed a predetermined number of times in this iteration of the object placement process. Thus, since the object placement process is ended even if a predetermined number of non-player objects have not been placed in the field, it is possible to prevent the amount of time required for the object placement process from becoming long. Note that in other embodiments, this determination may be made based on whether the number of non-player objects in the field has exceeded the upper-limit placeable number, or may be made based on whether the number of non-player objects that have been newly placed by the object placement process has exceeded a predetermined number. If the determination result from step S19 is negative, the process of step S11 is executed again.

Then, when step S11 is executed again, the candidate position data stored in the memory is reset, and the candidate position data indicating candidate positions that have been newly set is stored in the memory. On the other hand, if the determination result from step S19 is affirmative, the processor 21 ends the object placement process. After the object placement process is ended, the process of step S6 shown in FIG. 10 is executed.

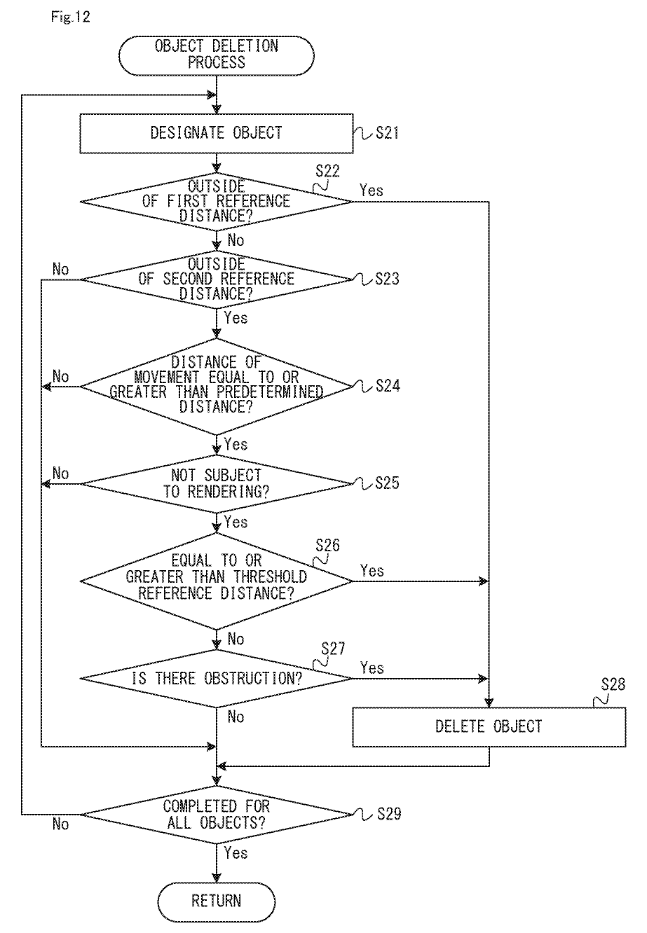

In step S6 shown in FIG. 10, the processor 21 executes an object deletion process of deleting a non-player object in the field under a predetermined condition. The details of the object deletion process of step S6 will now be described with reference to FIG. 12.

FIG. 12 is a sub-flowchart showing an example of a detailed flow of the object deletion process of step S6 shown in FIG. 10. In the object deletion process shown in FIG. 12, first, in step S21, the processor 21 designates one non-player object in the field. In step S21, a non-player object is designated from among the non-player objects in the field that has not been designated in the current iteration of the object deletion process. The process of step S22 is executed, following step S21 is executed.

In step S22, the processor 21 determines whether the position of the non-player object designated in step S21 is outside the range of the first reference distance from the reference position. The determination of step S22 is a determination for the first deletion condition described above. The processor 21 makes the determination of step S22 based on the data of the reference position based on the player character data, and the position data of this non-player object included in the object data. If the determination result from step S22 is negative, the process of step S23 is executed. On the other hand, if the determination result from step S22 is affirmative, the process of step S28 is executed.

In step S23, the processor 21 determines whether the non-player object designated in step S21 is outside the range of the second reference distance from the reference position. The determination of step S23 is a determination for the first sub-condition of the second deletion condition described above. The processor 21 makes the determination of step S23 based on the data of the reference position based on the player character data, and the position data of this non-player object included in the object data. If the determination result from step S23 is affirmative, the process of step S24 is executed. On the other hand, if the determination result from step S23 is negative, the process of step S29 is executed. In this case, the first deletion condition and the second deletion condition are both not satisfied, and therefore the deletion process (step S28) is not performed for this non-player object.

In step S24, the processor 21 determines whether the distance of movement of the player character since the generation of the non-player object designated in step S21 is equal to or greater than a predetermined distance. The determination of step S24 is a determination for the second sub-condition of the second deletion condition described above. In the exemplary embodiment, the processor 21 identifies the position of the player character at the time of generation of this non-player object based on the data indicating the timing at which this non-player object was generated (included in the object data), and the data indicating the position history of the player character (included in the player character data). Then, the distance of movement for the player character is calculated based on the identified position and the current position of the player character, and the determination of step S24 is made based on the calculated distance of movement. If the determination result from step S24 is affirmative, the process of step S25 is executed. On the other hand, if the determination result from step S24 is negative, the process of step S29 is executed. In this case, the first deletion condition and the second deletion condition are both not satisfied, and therefore the deletion process (step S28) is not performed for this non-player object.

In step S25, the processor 21 determines whether the non-player object designated in step S21 has been not subject to the rendering process for the first reference period of time or longer. The determination of step S25 is a determination for the third sub-condition of the second deletion condition described above. For example, the processor 21 determines, for each iteration of the process loop of steps S1 to S8, whether this non-player object has been actually rendered. For example, when a non-player object is designated in step S21, the processor 21 may make the determination for this non-player object based on the rendering result of the process in step S7 for the preceding frame. In the exemplary embodiment, the processor 21 stores the determination result described above, and makes the determination of step S25 by determining whether the state where the determination result is affirmative has continued for the first reference period of time at the current point in time. If the determination result from step S25 is affirmative, the process of step S26 is executed. On the other hand, if the determination result from step S25 is negative, the process of step S29 is executed. In this case, the first deletion condition and the second deletion condition are both not satisfied, and therefore the deletion process (step S28) is not performed for this non-player object.

In step S26, the processor 21 determines whether the distance from the position of the non-player object designated in step S21 to the reference position is equal to or greater than a threshold reference distance. The processor 21 makes the determination of step S26 based on the data of the reference position based on the player character data, and the position data of this non-player object included in the object data. If the determination result from step S26 is negative, the process of step S27 is executed. On the other hand, if the determination result from step S25 is affirmative, the process of step S28 is executed.

In step S27, the processor 21 determines whether the state where an obstruction exists between the position of the non-player object designated in step S21 and the virtual camera has continued for a second reference period of time or longer. The determination of step S27 is a determination for the fourth sub-condition of the second deletion condition described above. For example, the processor 21 determined, for each iteration of the process loop of steps S1 to S8, whether an obstruction exists between the position of this non-player object and the virtual camera based on the position data of this non-player object included in the object data, the camera data, and the data of objects included in the field data. For example, when a non-player object is designated in step S21, the processor 21 may make the determination for this non-player object. In the exemplary embodiment, the processor 21 stores the determination result described above, and makes the determination of step S27 by determining whether the state where the determination result is affirmative has continued for the second reference period of time. If the determination result from step S27 is affirmative, the process of step S28 is executed. On the other hand, if the determination result from step S27 is negative, the process of step S29 is executed. In this case, the first deletion condition and the second deletion condition are both not satisfied, and therefore the deletion process (step S28) is not performed for this non-player object.

In step S28, the processor 21 deletes the non-player object designated in step S21 from the field. The processor 21 updates the object data stored in the memory so that the data of this non-player object is deleted. The process of step S29 is executed, following step S28 is executed.

In step S29, the processor 21 determines whether the process of making determinations for the deletion condition (S22 to S27) has been completed for each non-player object in the field. If the determination result from step S29 is negative, the process of step S21 is executed again, and a non-player object for which the determination process described above has not been completed is designated when step S21 is executed again. On the other hand, if the determination result from step S29 is affirmative, the processor 21 ends the object deletion process. After the object deletion process is ended, the process of step S7 shown in FIG. 10 is executed.

In step S7 shown in FIG. 10, the processor 21 generates and displays a game image. The processor 21 generates a game image representing the virtual space as viewed from the virtual camera based on the virtual camera set in step S3, and displays the generated game image on a display device. In the exemplary embodiment, the placement status of non-player objects is updated by the object placement process and the object deletion process described above, and a game image of the virtual space is generated so that the game image includes non-player objects whose placement status has been updated and which are within the field of view of the virtual camera. The game image generated in step S7 is output to and displayed on the display device at a cycle of once per frame. Note that the display device on which the generated game image is displayed may be the display 12 of the main body apparatus 2 or another display device connected to the main body apparatus 2. The process of step S8 is executed, following step S7 is executed.

In step S8, the processor 21 determines whether or not to end the game. For example, the processor 21 determines to end the game when the game performs a predetermined operation input for ending the game. If the determination result from step S8 is negative, the process of step S1 is executed again. Thereafter, the series of processes of steps S1 to S8 is repeatedly executed until it is determined to end the game in step S8. On the other hand, if the determination result from step S8 is affirmative, the processor 21 ends the game process shown in FIG. 10.

### 4. Functions/Effects And Variations Of Exemplary Embodiment

In the embodiment described above, the game system 1 places a non-player object based on a candidate position that satisfies conditions, using the condition that no obstruction exists between the reference position and the candidate position (the second placement condition) and the condition that the reference position and the candidate position are located in the same range (the first placement condition). Thus, it is possible to suppress situations where non-player objects appear few in the field. For example, even when the placeable range for non-player objects is wide, it is possible to suppress the placement of many non-player objects at positions that are difficult to be displayed on the screen. For example, when the upper-limit placeable number and the placeable range are both increased in order to increase the number of non-player objects placed, it is possible to suppress the phenomenon where non-player objects are placed at positions that are difficult to be displayed on the screen because of the enlarged placeable range so that it appears that the number of non-player objects placed has not increased significantly.

In the embodiment described above, the reference position is used for making determinations for the placement condition and the deletion condition, and this reference position is always the same position (specifically, the position of the player character). Now, in other embodiments, the reference position used for making determination for different conditions may be determined by different methods for different conditions, and the reference position may be different positions for different conditions. For example, the game system 1 may use the position of the player character as the reference position for the determination for the placement condition, and use the middle position between the player character and the virtual camera as the reference position for the determination for the deletion condition. Also, for example, the position of the player character may be used as the reference position for the first placement condition, and the middle position may be used as the reference position for the second placement condition.

Note that, in the embodiment described above, where a process is executed using data (meaning including a program) in a first information processing apparatus, a part of the data necessary for the process may be transmitted from a second information processing apparatus that is different from the first information processing apparatus. In this case, the first information processing apparatus may execute the process using data stored therein and data received from the second information processing apparatus.

Note that in other embodiments, the information processing system does not need to include some of the components of the embodiment described above and does not need to execute some of the processes that are executed in the embodiment described above. For example, in order to achieve some particular results of the embodiment described above, the information processing system may only need to include a component or components for achieving said results and execute a process or processes for achieving said results, and the information processing system does not need to include other components and does not need to execute other processes.

The embodiment described above can be used, for example, as a game program or a game system, with the aim of suppressing situations where objects placed in the virtual space appear few, for example.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable storage media having stored therein instructions that, when executed, cause one or more processors to execute information processing comprising:
moving a player character in a field in a virtual space based on an operation input;
generating and placing a non-player object based on a candidate position if at least one of a first condition and a second condition is satisfied, wherein
the candidate position is set in a first range in the virtual space, the first range being set with respect to a first reference position, and the first reference position being set based on at least one of a position of the player character and a position of a virtual camera,
the first condition is that no obstruction exists between the candidate position and a second reference position, the second reference position being set based on at least one of the position of the player character and the position of the virtual camera, and
the second condition is that an obstruction exists between the candidate position and the second reference position, and where a third reference position, which is set based on at least one of the position of the player character and the position of the virtual camera, and the candidate position are both in a second range set in the field or are both in a third range set outside the second range; and
generating and placing one or more non-player objects up to a first number based on a plurality of candidate positions.

2. The one or more non-transitory computer-readable storage media according to claim 1, wherein the second range is a range representing an area enclosed by a wall placed in the field.

3. The one or more non-transitory computer-readable storage media according to claim 1, the information processing comprising randomly setting a plurality of candidate positions in the first range.

4. The one or more non-transitory computer-readable storage media according to claim 1, the information processing further comprising generating a non-player object excluding a case where the candidate position is inside an object in the virtual space.

5. The one or more non-transitory computer-readable storage media according to claim 1, the information processing further comprising generating a non-player object excluding a case where the number of non-player objects in a fifth range including the candidate position is equal to or greater than a second number smaller than the first number.

6. The one or more non-transitory computer-readable storage media according to claim 1, the information processing further comprising deleting a non-player object that satisfies a deletion condition, the deletion condition at least including a condition that the non-player object is outside a fourth range, the fourth range being set with respect to a fourth reference position, and the fourth reference position being set based on at least one of the position of the player character and the position of the virtual camera.

7. The one or more non-transitory computer-readable storage media according to claim 6, wherein the deletion condition further includes a condition that a state where an obstruction exists between a non-player object and a fifth reference position continues for a first period of time or longer, the fifth reference position being set based on at least one of the position of the player character and the position of the virtual camera.

8. The one or more non-transitory computer-readable storage media according to claim 6, wherein the deletion condition further includes a condition that a position of the non-player object is outside the fourth range has not been subject to a rendering process for a second period of time or longer.

9. The one or more non-transitory computer-readable storage media according to claim 8, wherein:
the deletion condition further includes a condition that the player character has moved a first amount of movement or more since the generation of the non-player object; and
the information processing further comprises controlling an orientation of the virtual camera based on an operation input.

10. An information processing system comprising:
one or more processors,
one or more memories having stored therein computer-executable instructions to execute information processing comprising:
moving a player character in a field in a virtual space based on an operation input;
generating and placing a non-player object based on a candidate position if at least one of a first condition and a second condition is satisfied, wherein
the candidate position is set in a first range in the virtual space, the first range being set with respect to a first reference position, and the first reference position being set based on at least one of a position of the player character and a position of a virtual camera,
the first condition is that no obstruction exists between the candidate position and a second reference position, the second reference position being set based on at least one of the position of the player character and the position of the virtual camera, and
the second condition is that an obstruction exists between the candidate position and the second reference position, and where a third reference position, which is set based on at least one of the position of the player character and the position of the virtual camera, and the candidate position are both in a second range set in the field or are both in a third range set outside the second range; and
generating and placing one or more non-player objects up to a first number based on a plurality of candidate positions.

11. The information processing system according to claim 10, wherein the second range is a range representing an area enclosed by a wall placed in the field.

12. The information processing system according to claim 10, the information processing comprising randomly setting a plurality of candidate positions in the first range.

13. The information processing system according to claim 10, the information processing further comprising generating a non-player object excluding a case where the candidate position is inside an object in the virtual space.

14. The information processing system according to claim 10, the information processing further comprising generating a non-player object excluding a case where the number of non-player objects in a fifth range including the candidate position is equal to or greater than a second number smaller than the first number.

15. The information processing system according to claim 10, the information processing further comprising deleting a non-player object that satisfies a deletion condition, the deletion condition at least including a condition that the non-player object is outside a fourth range, the fourth range being set with respect to a fourth reference position, and the fourth reference position being set based on at least one of the position of the player character and the position of the virtual camera.

16. The information processing system according to claim 15, wherein the deletion condition further includes a condition that a state where an obstruction exists between a non-player object and a fifth reference position continues for a first period of time or longer, the fifth reference position being set based on at least one of the position of the player character and the position of the virtual camera.

17. The information processing system according to claim 15, wherein the deletion condition further includes a condition that a position of the non-player object is outside the fourth range has not been subject to a rendering process for a second period of time or longer.

18. The information processing system according to claim 17, wherein:
the deletion condition further includes a condition that the player character has moved a first amount of movement or more since the generation of the non-player object; and
the information processing further comprises controlling an orientation of the virtual camera based on an operation input.

19. A computer-implemented method comprising:
moving a player character in a field in a virtual space based on an operation input;
generating and placing a non-player object based on a candidate position if at least one of a first condition and a second condition is satisfied, wherein
the candidate position is set in a first range in the virtual space, the first range being set with respect to a first reference position, and the first reference position being set based on at least one of a position of the player character and a position of a virtual camera,
the first condition is that no obstruction exists between the candidate position and a second reference position, the second reference position being set based on at least one of the position of the player character and the position of the virtual camera, and
the second condition is that an obstruction exists between the candidate position and the second reference position, and where a third reference position, which is set based on at least one of the position of the player character and the position of the virtual camera, and the candidate position are both in a second range set in the field or are both in a third range set outside the second range; and
generating and placing one or more non-player objects up to a first number based on a plurality of candidate positions.

20. The computer-implemented method according to claim 19, wherein the second range is a range representing an area enclosed by a wall placed in the field.

21. The computer-implemented method according to claim 19, comprising randomly setting a plurality of candidate positions in the first range.

22. The computer-implemented method according to claim 19, further comprising generating a non-player object excluding a case where the candidate position is inside an object in the virtual space.

23. The computer-implemented method according to claim 19, further comprising generating a non-player object excluding a case where the number of non-player objects in a fifth range including the candidate position is equal to or greater than a second number smaller than the first number.

24. The computer-implemented method according to claim 19, further comprising deleting a non-player object that satisfies a deletion condition, the deletion condition at least including a condition that the non-player object is outside a fourth range, the fourth range being set with respect to a fourth reference position, and the fourth reference position being set based on at least one of the position of the player character and the position of the virtual camera.

25. The computer-implemented method according to claim 24, wherein the deletion condition further includes a condition that a state where an obstruction exists between a non-player object and a fifth reference position continues for a first period of time or longer, the fifth reference position being set based on at least one of the position of the player character and the position of the virtual camera.

26. The computer-implemented method according to claim 24, wherein the deletion condition further includes a condition that a position of the non-player object is outside the fourth range has not been subject to a rendering process for a second period of time or longer.

27. The computer-implemented method according to claim 26, wherein:
the deletion condition further includes a condition that the player character has moved a first amount of movement or more since the generation of the non-player object; and
the computer-implemented method comprises controlling an orientation of the virtual camera based on an operation input.
